(19) United States
(12) Patent Application Publication
(10) Pub. No.: US 2019/0122214 A1
(43) Pub. Date: Apr. 25, 2019

(54) CONTROL PLANE IMPLEMENTED BY A MOBILE DEVICE AND PROVIDING IMPROVED SECURITY

(71) Applicant: Synchrony Bank, Draper, UT (US)

(72) Inventors: David H. Chau, Stamford, CT (US); Deepak Murthy, Stamford, CT (US); Dimitar Mitkov Dimitrov, Stamford, CT (US)

(21) Appl. No.: 15/788,700

(22) Filed: Oct. 19, 2017

(51) Int. Cl. G06Q 20/40; G06Q 20/32; G06Q 20/34

(52) U.S. Cl. CPC G06Q 20/401; G06Q 20/34; G06Q 20/3278

(57) ABSTRACT

A system implementing multi-factor authentication for use with a mobile communication device. The system includes a customer application, credit card, and payment authorization computing system. The customer application is configured to execute on the mobile communication device and to obtain an electronic token stored on the mobile communication device. The credit card is associated with a physical tag storing an electronic tag identifier. The tag identifier is readable wirelessly from the physical tag by the mobile communication device. The payment authorization computing system is configured to receive the token from the customer application when a credit card account associated with the credit card is locked, temporarily unlock the credit card account after receiving the electronic token, and authorize a payment from the credit card account while the credit card account is temporarily unlocked.

### BACKGROUND OF THE INVENTION

### Field of the Invention

The present invention is directed generally to security methods used to conduct transactions with mobile devices.

### Description of the Related Art

Adoption of mobile wallet technology has been slowed by two significant factors. First, mobile wallets have not been embraced by a clear majority of credit card holders. Second, many merchants have not invested in upgrades to their point-of-sale devices that are needed to conduct transactions using mobile wallets. For this reason, may consumers continue to use traditional physical credit cards, which provide insufficient security against fraudulent transactions. Thus, a need exists for methods of conducting secure credit card transactions. The present application provides these and other advantages as will be apparent from the following detailed description and accompanying figures.

### BRIEF DESCRIPTION OF THE SEVERAL VIEWS OF THE DRAWING(S)

FIG. 1 is a block diagram of a system in which a customer computing device functions as a control plane for a physical credit card.

FIG. 2 is a flow diagram of a method of conducting a transaction using the system of FIG. 1.

FIG. 3 is a flow diagram of a method of registering the credit card with a customer application executing on the customer computing device of FIG. 1.

FIG. 4 is a diagram of a hardware environment and an operating environment in which the customer computing device of FIG. 1 may be implemented.

FIG. 5 is a diagram of a hardware environment and an operating environment in which computing devices of the system of FIG. 1 may be implemented.

### DETAILED DESCRIPTION OF THE INVENTION

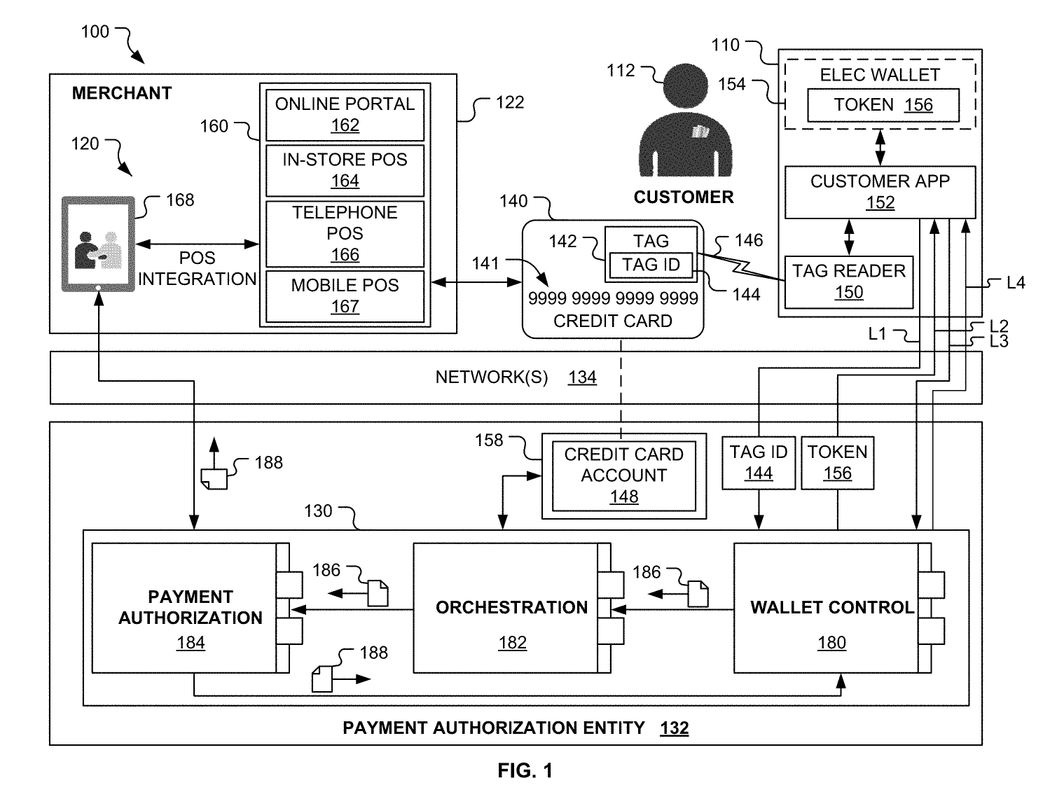

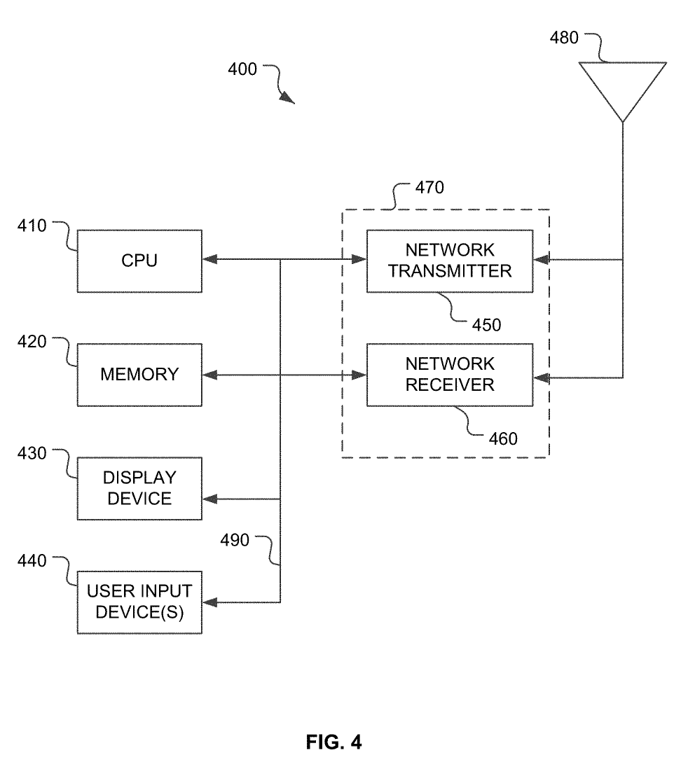

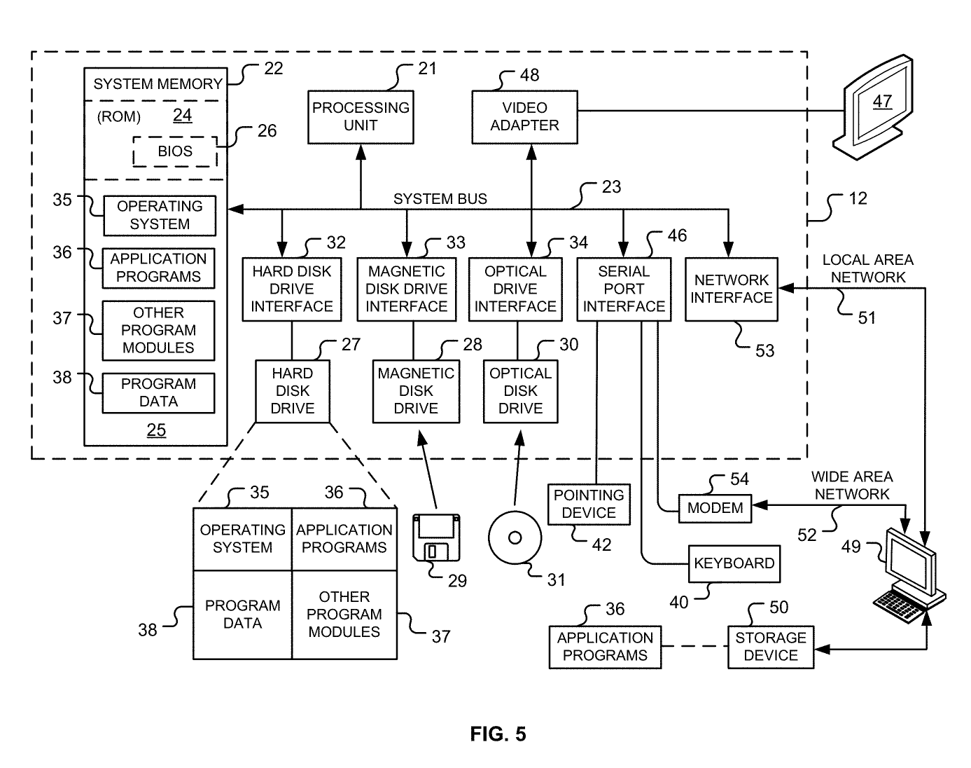

FIG. 1 is block diagram of a system 100 that includes a customer computing device 110 (e.g., a cellular telephone or similar mobile device) operated by a customer 112, a merchant computing system 120 operated by a merchant 122, and a payment authorization computing system 130 operated by a payment authorization entity 132. The payment authorization computing system 130 may be characterized as being a remote computing system with respect to the customer computing device 110 and/or the merchant computing system 120. The system 100 may include any number of customer computing devices each like the customer computing device 110 and each operated by a different customer. However, for ease of illustration, only the single customer computing device 110 has been illustrated and will be described below. Nevertheless, each of the customer computing devices may include substantially identical components and be configured to perform the same functions attributed to the customer computing device 110. Similarly, the system 100 may include any number of merchant computing systems each like the merchant computing system 120 operated by a different merchant. However, for ease of illustration, only the single merchant computing system 120 has been illustrated and will be described below. Nevertheless, each of the merchant computing systems may include substantially identical components and be configured to perform the same functions attributed to the merchant computing system 120. By way of a non-limiting example, the customer computing device 110 may be implemented as a mobile communication device 400 (illustrated in FIG. 4 and described). By way of another non-limiting example, the customer computing device 110 may be implemented as a computing device 12 (illustrated in FIG. 5 and described below). By way of yet another non-limiting example, the merchant computing system 120 and the payment authorization computing system 130 may each be implemented using one or more computing device (e.g., each like the computing device 12 illustrated in FIG. 5 and described below).

Returning to FIG. 1, the customer computing device 110 is configured to communicate with the payment authorization computing system 130 over one or more networks 134 (e.g., a cellular network, the plain old telephone service (“POTS”), and/or the Internet). Similarly, the merchant computing system 120 is also configured to communicate with the payment authorization computing system 130 over the network(s) 134 (e.g., the Internet, a payment processing network, and the like). Optionally, the customer computing device 110 may be configured to communicate with the merchant computing system 120 over the network(s) 134 (e.g., the cellular network, the POTS, and/or the Internet).

The customer 112 may have any number of credit cards each with a different tag and associated with a different credit card account. For ease of illustration, only a single credit card 140 has been illustrated and will be described below. The credit card 140 has a unique credit card number referred to as a primary account number (“PAN”) 141 associated with a credit card account 148. The credit card 140 is associated with a physical tag 142 (optionally, affixed to the tag 142). Therefore, the credit card 140 may be referred to as being a tagged credit card. The tag 142 is distinct, identifiable, and stores an electronic tag identifier (“ID”) 144 (e.g., a number, a string, and the like).

The tag 142 may be implemented as a sticker physically adhered to the credit card 140. By way of non-limiting examples, the tag ID 144 may be stored and communicated by a radio frequency identification (“RFID”) object (e.g., an RFID chip or an RFID tag), a near-field communication (“NFC”) object (e.g., an NFC chip or an NFC tag), and the like. The tag 142 may be implemented as an active tag or a passive tag. The tag 142 may have an operating frequency at which the tag 142 will communicate the tag ID 144. When implemented as an RFID object, the operating frequency of the tag 142 may be within a low frequency band, a high frequency band, or an ultra-high frequency band. As is apparent to those of ordinary skill in the art, an NFC object may operate in the same frequency band as a high frequency RFID object.

The customer 112 may receive the tag 142 from the payment authorization entity 132. For example, the customer 112 may submit a request to the payment authorization computing system 130 for the tag 142. In the request, the customer 112 identifies the credit card account 148 with which the tag 142 will be associated. After the payment authorization entity 132 approves the request, the tag 142 is issued to the customer 112. Before the payment authorization entity 132 sends the tag 142 to the customer 112 (e.g., via the mail), the payment authorization computing system 130 associates the tag ID 144 with the credit card account 148 and the PAN 141. The customer 112 receives and may affix the tag 142 to the credit card 140 (e.g., in accordance with any instructions provided with the tag 142).

The customer computing device 110 has a tag reader 150 configured to establish a wireless communication link 146 with the tag 142 and to use the communication link 146 to obtain the tag ID 144. In other words, the customer computing device 110 communicates with the tag 142 (using the tag's operating frequency) over the wireless communication link 146. For example, the customer computing device 110 may be implemented as an NFC device configured to read the tag ID 144 from the tag 142 when the tag 142 is implemented as an NFC object. Such an NFC device may also be configured to read the tag ID 144 when the tag 142 is implemented as an RFID object (e.g., a passive high frequency RFID tag). The tag reader 150 includes hardware and/or software components required to establish the communication link 146 and read the tag ID 144. Such hardware and/or software components are well known and, therefore, not described in detail herein.

The tag ID 144 may be obtained only from the tag 142. The tag reader 150 can obtain the tag ID 144 over the communication link 146 only when the tag 142 is within a reading distance of (or in near proximity to) the customer computing device 110. Thus, the system 100 allows the customer 112 to use the tagged credit card 140 only when the tagged credit card 140 is within the reading distance of the customer computing device 110. Therefore, the customer computing device 110 may be characterized as controlling whether the credit card account 148 associated with the tagged credit card 140 may be accessed and used to pay for a transaction (e.g., with the merchant 122). By way of a non-limiting example, when the tag 142 is implemented as an NFC object, the reading distance may extend about a few inches (e.g., about three inches) or about three feet away from the customer computing device 110. By way of another non-limiting example, when the tag 142 is implemented as an NFC object, the tag 142 and/or the credit card 140 must touch (or be tapped against) the customer computing device 110 to initiate reading the tag ID 144. By way of yet another non-limiting example, when the tag 142 is implemented as an RFID object, the reading distance may extend about three feet or about 37 feet outwardly from the customer computing device 110. By way of yet another non-limiting example, the reading distance may be about zero inches to about 20 inches.

The customer computing device 110 implements a customer application 152 and may optionally implement an electronic wallet 154. As mentioned above, the tag reader 150 is configured to read the tag ID 144 from the tag 142. The customer application 152 is configured to obtain the tag ID 144 from the tag reader 150 and, as illustrated by an arrow “L1,” send the tag ID 144 to the payment authorization computing system 130. In response and as illustrated by an arrow “L2,” the payment authorization computing system 130 sends an electronic token 156 to the customer application 152. The customer application 152 is configured to receive the token 156 from the payment authorization computing system 130 and store the token 156. The token 156 may be stored in the electronic wallet 154, the customer application 152, and/or in memory of the customer computing device 110 (e.g., memory 420 illustrated in FIG. 4 or system memory 22 of FIG. 5). The customer 112 may receive (e.g., download) the customer application 152 from the payment authorization computing system 130.

In FIG. 1, the credit card account 148 is stored by a credit account computing system 158, which may be implemented as a component of the payment authorization computing system 130. However, in alternate embodiments, the payment authorization computing system 130 may be connected to the credit account computing system 158 (e.g., by the network(s) 134). The payment authorization computing system 130 is configured to access the credit card account 148 by communicating with the credit account computing system 158 (e.g., over the network(s) 134). The credit account computing system 158 may be operated by the payment authorization entity 132 or a third party. The credit account computing system 158 may be implemented using one or more computing device (e.g., each like the computing device 12 illustrated in FIG. 5 and described below).

The merchant computing system 120 includes one or more points-of-sale 160 (e.g., an online portal 162, an in-store point-of-sale 164, a telephone point-of-sale 166, a mobile point-of-sale device 167, and the like). Each point-of-sale 160 is configured to conduct a transaction with the customer 112. Thus, each point-of-sale 160 is configured to receive and process transaction information (e.g., price) that includes credit card information (e.g., the PAN 141).

The merchant computing system 120 also includes one or more computing devices 168 each in communication with the payment authorization computing system 130. The computing device(s) 168 are configured to communicate with each point-of-sale 160 and the payment authorization computing system 130. For example, the computing device(s) 168 receive the transaction information (e.g., the PAN 141) from a selected one of the points-of-sale 160 (e.g., the in-store point-of-sale 164) and communicate the transaction information to the payment authorization computing system 130. In response, the payment authorization computing system 130 returns a notification to the computing device(s) 168 indicating whether the transaction is approved or declined. Then, the computing device(s) 168 sends a payment status notification 188 to the selected point-of-sale 160 (e.g., the in-store point-of-sale 164) indicating whether the transaction has been approved or declined. In some embodiments, one or more of the points-of-sale 160 and the computing device(s) 168 may be implemented by the same device or system.

By way of a non-limiting example, the online portal 162 includes a web server configured to communicate with the computing device(s) 168. The in-store point-of-sale 164 may include a human cashier, a cash register, and a credit card reader or other type of payment processing device. The telephone point-of-sale 166 may include a human telephone operator or an automated system configured to receive at least a portion of the transaction information (e.g., the PAN 141) and provide the transaction information to the computing device(s) 168.

By default, access to the credit card account 148 is locked by the payment authorization computing system 130 and is only temporarily unlocked (when appropriate) for each transaction separately. In other words, before the customer 112 can use the credit card 140, the payment authorization computing system 130 must unlock access to the credit card account 148. The payment authorization computing system 130 must also separately approve (or deny) payments from the credit card account 148. The customer application 152 functions a control plane that determines when the customer 112 (or a third party) may request that the payment authorization computing system 130 unlock the credit card account 148.

In the embodiment illustrated, the payment authorization computing system 130 includes software and/or hardware that implements a wallet control function 180, an orchestration function 182, and a payment authorization function 184. The wallet control function 180 generates the token 156 and associates the token 156 with the PAN 141, the credit card account 148, and the tag ID 144. As will be explained below, the wallet control function 180 also temporarily unlocks the credit card account 148 when appropriate. The orchestration function 182 may record the time and location of the customer computing device 110 when the temporary unlocking occurred. The orchestration function 182 may also record other transaction information that may be used to determine shopping habits and preferences in addition to the locality of the customer 112. The system 100 may be configured to provide fraud prevention on all channels (e.g., over the Internet or the online portal 162, the in-store point-of-sale 164, the telephone point-of-sale 166, the mobile point-of-sale device 167, and the like). By way of a non-limiting example, the mobile point-of-sale device 167 may be implemented as a Square point-of-sale device sold by Square, Inc., or similar mobile point-of-sale device. The orchestration function 182 may activate controls configured to prevent fraud. For example, the orchestration function 182 may provision a payment authorization process performed by the payment authorization function 184 and activate rules that help reduce or minimize fraud. These rules are followed or implemented by the payment authorization function 184 when it performs the payment authorization process. The payment authorization function 184 is configured to approve or deny payment from the credit card account 148 only after the wallet control function 180 has temporarily unlocked the credit card account 148.

As explained above, credit approval has three steps: (1) activating (by the tag 142) the control plane, (2) unlocking (by the wallet control function 180) the credit card account 148 and (3) approving (by the payment authorization function 184) payment from the credit card account 148. The first step requires the tag 142, the second step requires the token 156, and the third step requires the PAN 141. In other words, at least three different pieces of information are required for each transaction. Thus, this process may be characterized as a type of multi-factor authentication.

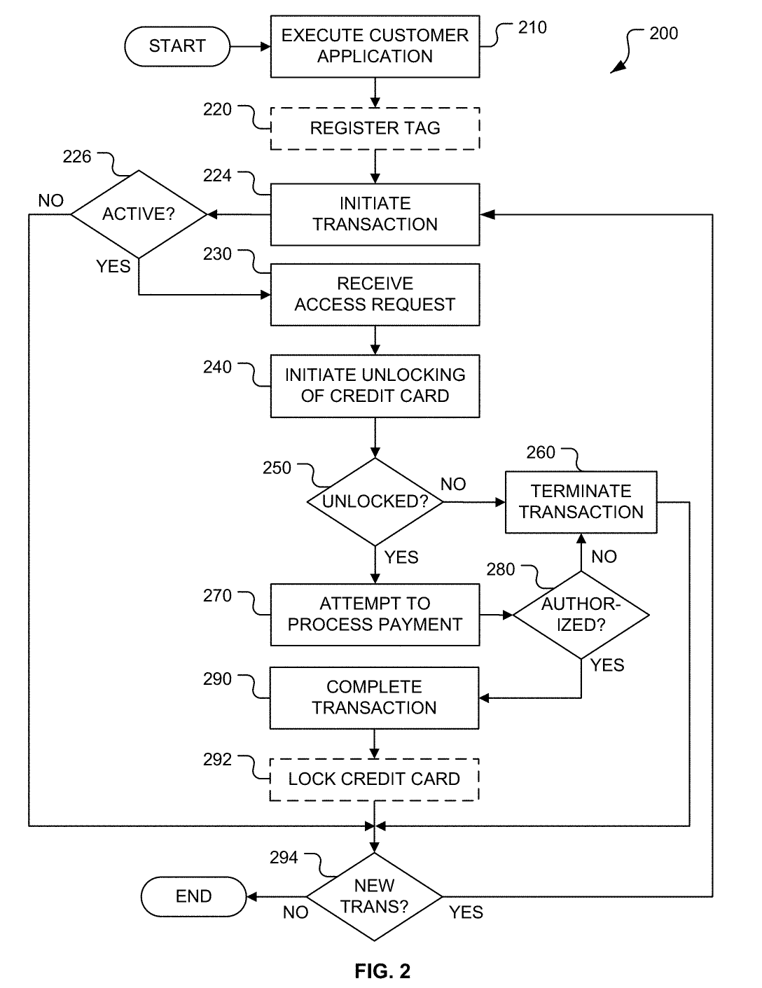

FIG. 2 is a flow diagram of a method 200 of conducting a transaction using by the system 100 (see FIG. 1). Referring to FIG. 1, in first block 210 (see FIG. 2), the customer computing device 110 executes the customer application 152. Before the customer application 152 is executed, the customer application 152 may be downloaded from the payment authorization computing system 130 and installed on the customer computing device 110.

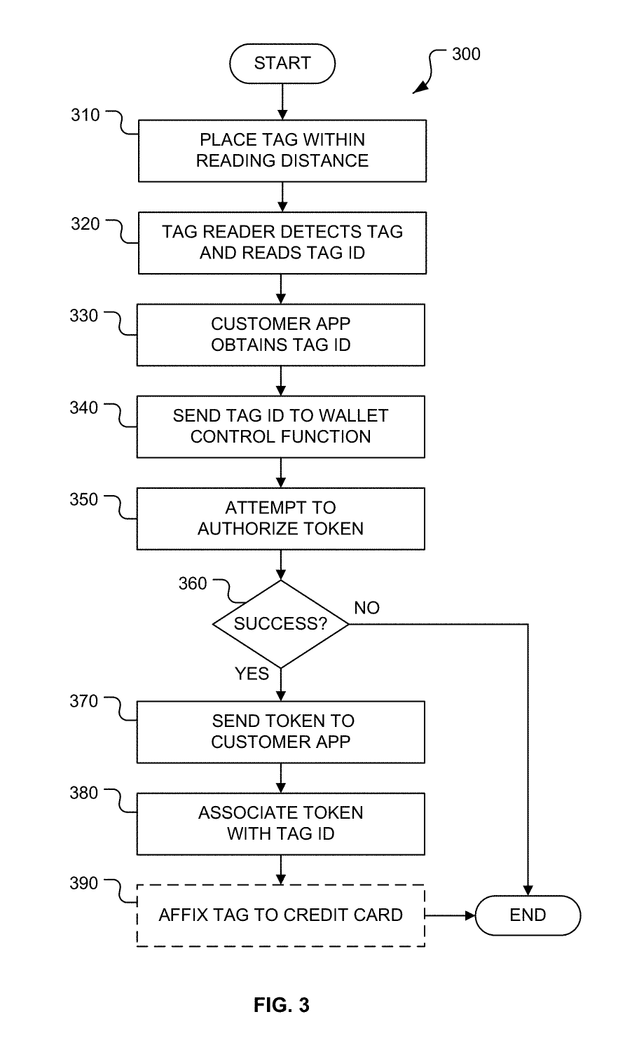

If the tag 142 has not yet been registered, in optional block 220 (see FIG. 2), the customer application 152 registers the tag 142 with the customer application 152. If the customer 112 has not yet done so, the customer 112 may affix the tag 142 to the credit card 140. The tag 142 may be registered with only a predetermined number (e.g., one, two, and the like) different instances of the customer application 152. For example, the payment authorization computing system 130 may allow the tag 142 to be registered with only one instance of the customer application 152. Thus, the tag 142 will be registered with only the single computing device (e.g., mobile telephone) executing that instance of the customer application 152. A method 300 of registering the tag 142 is illustrated in FIG. 3 and described below.

After block 220 (see FIG. 2) or if the tag 142 is already registered, the method advances to block 224 (see FIG. 2). In block 224 (see FIG. 2), the customer 112 initiates a transaction requiring payment from the credit card account 148. For example, in block 224, the customer 112 may go to a store, select an item, and present the item to a cashier who requests payment for the item. At this point, the customer 112 wishes to complete the transaction using the credit card 140, which is locked by the payment authorization computing system 130.

In decision block 226, the customer application 152 determines whether the control plane is active. As mentioned above, the customer application 152 functions a control plane that determines when the customer 112 may request that the payment authorization computing system 130 unlock the credit card account 148. The control plane is active when the tagged credit card 140 is within the reading distance of the customer computing device 110. On the other hand, the control plane is inactive when the credit card 140 is not within the reading distance of the customer computing device 110. Thus, the customer application 152 may be configured to detect when the credit card 140 is beyond the reading distance of the customer computing device 110 and the control plane is inactivate. The decision in decision block 226 is “YES,” when the customer application 152 determines the control plane is active. Otherwise, the decision in decision block 226 is “NO.”

Referring to FIG. 2, when the decision in decision block 226 is “NO,” the method 200 advances to decision block 294. On the other hand, when the decision in decision block 226 is “YES,” in block 230, the customer application 152 (see FIG. 1) receives a request to access the credit card account 148 (see FIG. 1). For example, referring to FIG. 1, in block 230 (see FIG. 2), the customer application 152 may receive a selection of the tagged credit card 140 from the customer 112 indicating the customer 112 would like to use the tagged credit card 140 to provide payment for the transaction initiated in block 224 (see FIG. 2). For example, in block 230 (see FIG. 2), the customer application 152 may display a selectable visual identifier representing the tagged credit card 140 on a display device (e.g., a display device 430 illustrated in FIG. 4). The customer 112 may select the selectable visual identifier (e.g., by tapping or clicking on it) to communicate the selection of the tagged credit card 140 to the customer application 152. By way of another non-limiting example, the customer 112 may tap the tagged credit card 140 (e.g., in which the tag 142 is implemented as an NFC object) onto the customer computing device 110 (e.g., implemented as an NFC device) to communicate the request to the customer application 152.

In block 240 (see FIG. 2), the customer application 152 initiates unlocking the tagged credit card 140. The customer application 152 may initiate unlocking the tagged credit card 140 by using the tag ID 144 to obtain the token 156 (e.g., from the electronic wallet 154) and sending access request information (including the token 156) to the wallet control function 180 of the payment authorization computing system 130 (illustrated by an arrow “L3”). Optionally, the access request information may include the tag ID 144, authentication information, auxiliary account information (e.g., loyalty points), and the like. The authentication information may include one or more passwords, one or more answers to security questions, and/or biometric data (e.g., a fingerprint, a face scan, and the like). By way of a non-limiting example, if the tag reader 150 is implemented as a NFC device, the auxiliary account information can be read from the tag 142 and obtained by the customer application 152, which can transfer the auxiliary account information to the wallet control function 180. The customer application 152 may also send a frequency of use of the control plane and the tagged credit card 140 and/or the electronic wallet 154 to the wallet control function 180. By way of another non-limiting example, the customer application 152 may send a customer affinity to specific point-of-sale locations to the wallet control function 180, which the payment authorization computing system 130 can share with the merchant 122 to enhance (e.g., personalize) customer experiences.

In decision block 250 (see FIG. 2), the wallet control function 180 decides whether to unlocked the credit card account 148 (and the credit card 140). By way of a non-limiting example, in decision block 250 (see FIG. 2), the wallet control function 180 may determine whether the authentication information provided satisfies authentication requirements and may unlock the credit card account 148 when these requirements are satisfied. For example, in decision block 250, the payment authorization computing system 130 may include layered security (e.g., on top of the wallet control function 180) configured to enhance security (e.g., by performing biometric security checks and the like). By way of another example, the wallet control function 180 may determine whether the token 156 is valid and unlock the credit card account 148 (and the credit card 140) associated with the token 156 if the token 156 is determined to be valid. For example, the token 156 may be determined to be valid if the tag ID 144 sent with the token 156 is associated with the token 156 in the payment authorization computing system 130. Otherwise, if the token 156 is determined to be invalid, the credit card account 148 (and the credit card 140) remains locked. The decision in decision block 250 (see FIG. 2) is “YES,” when the wallet control function 180 unlocks the credit card account 148 (and the credit card 140). Otherwise, the decision in decision block 250 (see FIG. 2) is “NO.”

Referring to FIG. 2, when the decision in decision block 250 is “NO,” in block 260, the customer 112 (see FIG. 1) is prevented from completing the transaction (e.g., the transaction terminates). Optionally, referring to FIG. 1, the wallet control function 180 may send an access denied notification (not shown) to the customer application 152 and/or the tag 142. The access denied notification (not shown) indicates that the tagged credit card 140 remains locked. The customer application 152 may optionally display a notification to the customer 112 (e.g., on the display device 430 illustrated in FIG. 4) that the tagged credit card 140 remains locked. Then, the method 200 advances to decision block 294. Alternatively, the customer application 152 may return to block 230 and allow the customer 112 to select an alternate method of payment.

Referring to FIG. 2, when the decision in decision block 250 is “YES,” in block 270, the customer 112 (see FIG. 1) attempts to use the tagged credit card 140 (see FIG. 1) to complete the transaction (e.g., the customer 112 presents the credit card 140) and the payment authorization function 184 (see FIG. 1) determines whether to authorize payment. For example, referring to FIG. 1, the customer 112 may present the physical credit card 140 to a cashier (e.g., at the in store point-of-sale 164) who uses a credit card reader to read credit card information (e.g., the PAN 141) from the credit card 140 and forward the transaction information to the computing device(s) 168. Alternatively, the customer 112 may enter the credit card information (e.g., the PAN 141) directly into the point-of-sale 160 (e.g., the online portal 162), which forwards the transaction information to the computing device(s) 168. Optionally, the credit card information (e.g., the PAN 141) may be stored in the electronic wallet 154 and forwarded by the electronic wallet 154 to one of the points-of-sale 160. By way of another non-limiting example, a telephone operator (e.g., at the telephone point-of-sale 166) may enter the credit card information (e.g., the PAN 141) into a computing device that forwards the transaction information to the computing device(s) 168. As mentioned above, the computing device(s) 168 send the transaction information to the payment authorization function 184.

Also in block 270 (see FIG. 2), the wallet control function 180 sends an access granted notification 186 to the payment authorization function 184 indicating the credit card account 148 (and the credit card 140) has been unlocked. The access granted notification 186 may include the time and location of the customer computing device 110 when the unlocking occurred. The wallet control function 180 may send the access granted notification 186 to the orchestration function 182, which forwards the access granted notification 186 to the payment authorization function 184. In such embodiments, the orchestration function 182 may record the time and location of the customer computing device 110 when the unlocking occurred. The orchestration function 182 is configured to activate controls configured to prevent fraud. The wallet control function 180 may identify and activate one or more fraud prevention controls that the orchestration function 182 instructs the payment authorization function 184 to use. For example, the orchestration function 182 may provision the payment authorization process performed by the payment authorization function 184 and activate rules to be followed by the payment authorization function 184 that help reduce or minimize fraud. Examples of such rules includes imposing self-service credit limits and enabling or disabling money transfers (e.g., between different card holders) and limited transfers of credit lines.

Optionally, the wallet control function 180 may send an access granted notification (not shown) to the customer application 152 and/or the tag 142. The access granted notification (not shown) indicates that the tagged credit card 140 has been unlocked. The customer application 152 may optionally display a notification to the customer 112 (e.g., on the display device 430 illustrated in FIG. 4) that the tagged credit card 140 has been unlocked.

In decision block 280 (see FIG. 2), the payment authorization function 184 performs the payment authorization process and decides whether to authorize the transaction. The payment authorization function 184 sends the payment status notification 188 to the computing device(s) 168 and/or the wallet control function 180. The payment status notification 188 indicates whether the transaction has been authorized or denied. The decision in decision block 280 (see FIG. 2) is “YES,” when the payment authorization function 184 authorizes the transaction. Otherwise, the decision in decision block 280 (see FIG. 2) is “NO.”

Referring to FIG. 2, when the decision in decision block 280 is “YES,” in block 290, the customer 112 (see FIG. 1) completes the transaction. Optionally, referring to FIG. 1, the wallet control function 180 may send a notification (illustrated by an arrow “L4”) to the customer computing device 110 indicating that the transaction has been authorized. The customer computing device 110 may optionally display (using the display device 430 illustrated in FIG. 4) a message to the customer 112 indicating that the transaction was authorized. After the transaction is completed, the credit card account 148 (and the credit card 140) returns to being locked. This may occur without any additional action on the part of the system 100. Alternatively, in optional block 292 (see FIG. 2), the system 100 may lock the credit card account 148 (and the credit card 140). Then, referring to FIG. 2, the method 200 advances to decision block 294.

When the decision in decision block 280 is “NO,” in block 260, the customer 112 (see FIG. 1) is prevented from completing the transaction (e.g., the transaction terminates). Referring to FIG. 1, the wallet control function 180 may send the notification (illustrated by the arrow “L4”) to the customer computing device 110 indicating that the transaction has been denied. The customer computing device 110 may display (e.g., on the display device 430 illustrated in FIG. 4) a message to the customer 112 indicating that authorization was denied. Optionally, the customer application 152 may return to block 230 (see FIG. 2) and allow the customer 112 to select an alternate method of payment. Alternatively, referring to FIG. 2, the method 200 advances to decision block 294.

In decision block 294, the customer 112 (see FIG. 1) decides whether to conduct a new transaction. The decision in decision block 294 is “YES,” when the customer 112 (see FIG. 1) wishes to conduct a new transaction. When the decision in decision block 294 is “YES,” the method 200 returns to block 224 whereat the new transaction is initiated. Otherwise, when the customer 112 (see FIG. 1) does not wish to conduct a new transaction, the decision in decision block 294 is “NO” and the method 200 terminates.

The method 200 provides a new and novel approach to resolving credit authorization requests at each of the points-of-sale 160 (see FIG. 1) and allows the customer application 152 (see FIG. 1) to function as the control plane for the transaction. The method 200 also provides multi-factor authentication and therefore improves security.

FIG. 3 is a flow diagram of the method 300 of registering the tagged credit card 140 (see FIG. 1). The method 300 may be performed in block 220 (see FIG. 2) of the method 200 (see FIG. 2). Referring to FIG. 1, in first block 310 (see FIG. 3), the customer 112 places the tag 142 within the reading distance of the customer computing device 110 (e.g., the tagged credit card 140 may be tapped against the customer computing device 110).

Then, in block 320 (see FIG. 3), the tag reader 150 detects the tag 142 and reads the tag ID 144. In block 330 (see FIG. 3), the customer application 152 obtains the tag ID 144 from the tag reader 150. In block 340 (see FIG. 3), the customer application 152 sends the tag ID 144 to the payment authorization computing system 130. For example, the customer application 152 may send the tag ID 144 to the wallet control function 180. As mentioned above, the payment authorization computing system 130 associates the tag ID 144 with the credit card account 148 (which is associated with the credit card 140).

Next, in block 350 (see FIG. 3), the customer 112 attempts to authorize receipt of the token 156 using the customer application 152. For example, in block 350 (see FIG. 3), the customer 112 may log onto the credit card account 148 and/or provide other required authorization information in response to requests from the customer application 152. This information is forwarded to the wallet control function 180, which determines whether sending the token 156 to the customer application 152 is authorized by the customer 112.

In decision block 360 (see FIG. 3), the payment authorization computing system 130 (e.g., the wallet control function 180) decides whether the customer 112 has successfully authorized the receipt of the token 156. The decision in decision block 360 (see FIG. 3) is “YES,” when the customer 112 has successfully authorized the receipt of the token 156. Otherwise, the decision in decision block 360 (see FIG. 3) is “NO.”

Referring to FIG. 3, when the decision in decision block 360 is “NO,” the method 300 terminates. On the other hand, referring to FIG. 1, when the decision in decision block 360 (see FIG. 3) is “YES,” in block 370 (see FIG. 3), the wallet control function 180 associates the token 156 with the tag ID 144 and sends the token 156 to the customer application 152. Optionally, the wallet control function 180 may generate the token 156 before sending the token 156 to the customer application 152.

In block 380 (see FIG. 3), the customer application 152 associates the token 156 with the tag ID 144. Optionally, the customer application 152 may store the token 156 in the electronic wallet 154. The token 156 represents the credit card account 148 (and the credit card 140). Optionally, the electronic wallet 154 may associate the token 156 with the tag ID 144. Neither the customer application 152 nor the electronic wallet 154 stores information identifying the credit card 140 (e.g., the PAN 141). The token 156 may be sent to the payment authorization computing system 130 by the customer computing device 110 instead of the credit card information (e.g., the PAN 141).

At this point, the tagged credit card 140 is registered. Registering the tagged credit card 140 associates it with both the customer 112 (who is the owner of the credit card account 148) and the customer computing device 110. Registration establishes the customer application 152 executing on the customer computing device 110 as a control plane for the credit card 140. In other words, the credit card 140 can only be used to conduct a transaction after the customer application 152 sends the access request information (illustrated by the arrow “L3” and including the token 156) to the wallet control function 180 and the wallet control function 180 unlocks the credit card account 148 (and the credit card 140).

In optional block 390 (see FIG. 3), the customer 112 may affix the tag 142 to the credit card 140. Then, the method 300 terminates.

As explained above, the customer application 152 controls at least in part whether the tagged credit card 140 is locked or unlocked. The tagged credit card 140 may be unlocked only when the customer application 152 initiates unlocking by sending the access request information (illustrated by the arrow “L3”) to the wallet control function 180 and the wallet control function 180 unlocks the tagged credit card 140. On the other hand, when the tagged credit card 140 is locked, any use of the tagged credit card 140 is automatically declined by the payment authorization computing system 130. Thus, if the tagged credit card 140 is lost or misplaced, the credit card account 148 is automatically protected from fraudulent and criminal activities.

By interfacing the customer computing device 110 with the existing physical credit cards (e.g., the credit card 140), the interface between the physical credit cards and the points-of-sale 160 remains intact and unchanged. Further, consumer and merchant behavior remains largely unchanged. Nevertheless, security is improved because the customer computing device 110 acts as a control plane and provides advanced features and services.

Mobile Communication Device

FIG. 4 is a functional block diagram illustrating the mobile communication device 400 that may be used to implement the customer computing devices (e.g., the customer computing device 110) of FIG. 1. By way of non-limiting examples, referring to FIG. 4, the mobile communication device 400 may be implemented as a cellular telephone, a tablet computer, and the like. The mobile communication device 400 includes a central processing unit (CPU) 410. Those skilled in the art will appreciate that the CPU 410 may be implemented as a conventional microprocessor, application specific integrated circuit (ASIC), digital signal processor (DSP), programmable gate array (PGA), or the like. The mobile communication device 400 is not limited by the specific form of the CPU 410.

The mobile communication device 400 also contains the memory 420. The memory 420 may store instructions and data to control operation of the CPU 410. The memory 420 may include random access memory, ready-only memory, programmable memory, flash memory, and the like. The mobile communication device 400 is not limited by any specific form of hardware used to implement the memory 420. The memory 420 may also be integrally formed in whole or in part with the CPU 410.

The mobile communication device 400 also includes conventional components, such as the display device 430 and one or more user input devices 440 (e.g., buttons, a keypad, a keyboard, and the like). These are conventional components that operate in a known manner and need not be described in greater detail. The display device 430 may be implemented as a touch display or touchscreen configured to receive user input (e.g., a selection of the selectable visual identifier representing the tagged credit card 140 illustrated in FIG. 1). By way of non-limiting examples, the display device 430 is operable to display the selectable visual identifier representing the tagged credit card 140 (see FIG. 1), the notification that the tagged credit card 140 remains locked or has been unlocked, the message to the customer 112 indicating that the transaction was authorized or denied, and the like.

The memory 420 stores computer executable instructions that when executed by the CPU 410 cause the CPU 410 to generate the screens and interfaces described above and displayed by the display device 430. Referring to FIG. 1, the memory 420 (see FIG. 4) also stores computer executable instructions that when executed by the CPU 410 implement the tag reader 150, the customer application 152, and the optional electronic wallet 154. Such instructions may be stored on one or more non-transitory computer-readable media. Returning to FIG. 4, other conventional components found in wireless communication devices, such as a USB interface, Bluetooth interface, camera/video device, infrared device, and the like, may also be included in the mobile communication device 400. For the sake of clarity, these conventional elements are not illustrated in the functional block diagram of FIG. 4.

The mobile communication device 400 also includes a network transmitter 450 such as may be used by the mobile communication device 400 for normal network wireless communication with the network(s) 134 (see FIG. 1), such as with a base station (not shown) of a cellular network. FIG. 4 also illustrates a network receiver 460 that operates in conjunction with the network transmitter 450 to communicate with the network(s) 134 (see FIG. 1), such as with the base station (not shown) of the cellular network. In a typical embodiment, the network transmitter 450 and network receiver 460 are implemented as a network transceiver 470. The network transceiver 470 is connected to an antenna 480. Operation of the network transceiver 470 and the antenna 480 for communication with the network(s) 134 (see FIG. 1) is well-known in the art and need not be described in greater detail herein.

While not illustrated in FIG. 4, referring to FIG. 1, as mentioned above, the mobile communication device 400 (see FIG. 4) includes hardware components (e.g., a transmitter, a receiver, and an antenna) configured to communicate over the communication link 146 with the tag 142 and read the tag ID 144 from the tag 142. The mobile communication device 400 (see FIG. 4) also include software components (e.g., stored in the memory 420 illustrated in FIG. 4) required to establish the communication link 146 and read the tag ID 144 from the tag 142.

Referring to FIG. 4, the mobile communication device 400 may also include a conventional geolocation module (not shown) operable to determine the current location of the mobile communication device 400.

The various components illustrated in FIG. 4 are coupled together by a bus system 490. The bus system 490 may include an address bus, data bus, power bus, control bus, and the like. For the sake of convenience, the various busses in FIG. 4 are illustrated as the bus system 490.

The memory 420 may store instructions executable by the CPU 410. The instructions may implement portions of one or more of the methods 200 and 300 illustrated in FIGS. 2 and 3, respectively. Such instructions may be stored on one or more non-transitory computer or processor readable media.

Computing Device

FIG. 5 is a diagram of hardware and an operating environment in conjunction with which implementations of the one or more computing devices of the system 100 may be practiced. The description of FIG. 5 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 5 includes a general-purpose computing device in the form of the computing device 12. Each of the computing devices mentioned above, including those illustrated in FIG. 1 (e.g., the customer computing device 110, the merchant computing system 120, and the payment authorization computing system 130), may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, a blade computer, and the like.

The computing device 12 includes the system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 5 include a local-area network (LAN) 51 and a wide-area network (WAN) 52. Such networking environments are commonplace in offices, enterprise-wide computer networks, intranets and the Internet. The network(s) 134 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200 and 300 illustrated in FIGS. 2 and 3, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system implementing multi-factor authentication for use with a mobile communication device, the system comprising:
a customer application configured to execute on the mobile communication device, the customer application being configured to obtain an electronic token stored on the mobile communication device;
a credit card associated with a physical tag storing an electronic tag identifier, the electronic tag identifier being readable wirelessly from the physical tag by the mobile communication device; and
a payment authorization computing system configured to receive the electronic token from the customer application when a credit card account associated with the credit card is locked, temporarily unlock the credit card account after receiving the electronic token, and authorize a payment from the credit card account while the credit card account is temporarily unlocked.

2. The system of claim 1, wherein the physical tag is a sticker adhered to the credit card.

3. The system of claim 1, wherein the physical tag is a radio frequency identification (“RFID”) object or a near-field communication (“NFC”) object.

4. The system of claim 1, wherein the payment authorization computing system is configured to provide the customer application to the mobile communication device.

5. The system of claim 1, wherein the payment authorization computing system is operated by an entity that issued the physical tag.

6. The system of claim 1, wherein the electronic tag identifier is readable wirelessly from the physical tag by the mobile communication device only when the physical tag is within a reading distance of the mobile communication device.

7. The system of claim 6, wherein the reading distance is about zero inches to about 20 inches.

8. The system of claim 1, wherein the electronic tag identifier is readable wirelessly from the physical tag by the mobile communication device when the physical tag is tapped on the mobile communication device.

9. The system of claim 1, wherein before the payment authorization computing system temporarily unlocks the credit card account, the payment authorization computing system receives authentication information and verifies authentication requirements are satisfied.

10. The system of claim 9, wherein the authentication information comprises biometric data and the authentication requirements include confirming the biometric data is associated with an owner of the credit card account.

11. A method of implementing multi-factor authentication, the method being for use with a physical tag associated with a credit card, the physical tag storing an electronic tag identifier, the credit card being associated with a credit card account, the method comprising:
receiving, at a computing system, an electronic token associated with the credit card account when the credit card account is locked preventing payments from being made therefrom, the electronic token being receivable from a customer application executing on a customer computing device only after the customer computing device reads the electronic tag identifier from the physical tag and the customer application uses the electronic tag identifier to obtain the electronic token;
temporarily unlocking, by the computing system, the credit card account after the computing system receives the electronic token;
receiving, at the computing system, a request for a payment from the credit card account, the request including a credit card number identifying the credit card associated with the credit card account; and
authorizing, by the computing system, the payment from the credit card account only when the credit card account is unlocked.

12. The method of claim 11, further comprising registering the physical tag before the computing system receives the electronic token, registering comprising:
receiving, at the computing system, the electronic tag identifier from the customer application;
obtaining, by the computing system, the electronic token associated with the credit card account; and
sending, from the computing system, the electronic token to the customer application in response to receiving the electronic tag identifier.

13. The method of claim 11 for use with the physical tag being a sticker adhered to the credit card, wherein the customer computing device comprises a tag reader configured to wirelessly read the electronic tag identifier from the physical tag only when the physical tag is within a reading distance of the customer computing device.

14. The method of claim 13, wherein the reading distance is about zero inches to about 20 inches.

15. The method of claim 11 for use with the physical tag being a radio frequency identification (“RFID”) object or a near-field communication (“NFC”) object, wherein the customer computing device is configured to read the electronic tag identifier from the physical tag wirelessly.

16. The method of claim 11, further comprising:
downloading, by the computing system, the customer application to the customer computing device.

17. The method of claim 11, wherein the request for the payment is received from a merchant computing system comprising a credit card reader, the credit card number having been read from the credit card by the credit card reader.

18. The method of claim 11, further comprising:
receiving, by the computing system, authentication information from the customer computing device, temporarily unlocking the credit card account comprising temporarily unlocking the credit card account when the authentication information satisfies authentication requirements.

19. A method of implementing multi-factor authentication, the method comprising:
reading, with a mobile communication device, a physical tag to obtain an electronic tag identifier, the mobile communication device storing an electronic token associated with the electronic tag identifier;
obtaining, at the mobile communication device, the electronic token after reading the physical tag;
sending, with the mobile communication device, the electronic token to a remote computing system, the remote computing system being configured to unlock a credit card account associated with the electronic token after the remote computing system receives the electronic token, the remote computing system being configured to authorize a payment from the credit card account only if the credit card account has been unlocked;
receiving, by the mobile communication device, a notification from the remote computing system indicating whether the payment was authorized or denied; and
displaying, by the mobile communication device, an indication of whether the payment was authorized or denied.

20. The method of claim 19, further comprising registering the physical tag before obtaining the electronic token, registering comprising:
reading, with the mobile communication device, the physical tag to obtain the electronic tag identifier;
sending, with the mobile communication device, the electronic tag identifier to the remote computing system;
receiving, at the mobile communication device, the electronic token from the remote computing device; and
storing the electronic token on the mobile communication device.

21. The method of claim 19, wherein the physical tag is a radio frequency identification (“RFID”) object or a near-field communication (“NFC”) object and the mobile communication device is configured to read the electronic tag identifier from the physical tag wirelessly.

22. The method of claim 19, wherein the physical tag is readable wirelessly by the mobile communication device only when the physical tag is within a reading distance of the mobile communication device.

23. The method of claim 22, wherein the reading distance is about zero inches to about 20 inches.

24. The method of claim 19, wherein the physical tag is readable wirelessly by the mobile communication device when the physical tag is tapped on the mobile communication device.
